(19) United States
(12) Patent Application Publication
(10) Pub. No.: US 2010/0289223 A1
(43) Pub. Date: Nov. 18, 2010

(54) REGENERATIVE HEAT EXCHANGER AND METHOD OF REDUCING GAS LEAKAGE THEREIN

(76) Inventors: James W. Birmingham, Wellsville, NY (US); Glen D. Jukkola, Glastonbury, CT (US); Aku P. Rainio, Avon, CT (US)

Correspondence Address: ALSTOM Power Inc., 200 Great Pond Drive, P.O. Box 500, WINDSOR, CT, 06095, US

(21) Appl. No.: 12/465,754

(22) Filed: May 14, 2009

(51) Int. Cl. F16J 15/34; F28D 11/02; F27D 17/00

(52) U.S. Cl. 277/306; 165/88; 432/180; 110/254

(57) ABSTRACT

A heat exchanger 500 for transferring heat between a first gas flow 28, such as flue gases, and a second gas flow 34, such as air or oxygen, includes a housing 514 having a first inlet plenum 520 for receiving the first gas flow 28, a first outlet plenum 522 for discharging the first gas flow 28, a second inlet plenum 526 for receiving the second gas flow 34, and a second outlet plenum 528 for discharging the second gas flow 34. The heat exchanger 500 further includes heat exchange elements 512 disposed within the housing 514. Radial seals 224, 226, 228, 230 are disposed between the housing 514 and the heating elements 512 that define a radial plenum 535, 536. Axial seals 220, 222 are further disposed between the housing 514 and the heating elements 512 to define an axial plenum 530. A third gas flow, such as recirculated flue gas, is provided in the radial plenum 535, 536 and the axial plenum 530 to reduce the leakage between the first gas flow 28 and the second gas flow 34.

### TECHNICAL FIELD

The present disclosure relates generally to a regenerative heat exchanger, and more specifically, to a rotary regenerative heat exchanger, such as a rotary regenerative air preheater, having reduced gas leakage between the inlet and outlet plenums therein, and a method of using the regenerative heat exchanger.

### BACKGROUND

There is growing concern that emission of CO₂ and other greenhouse gases to the atmosphere is resulting in climate change and other as yet unknown consequences. Because existing fossil fuel fired power plants are among the largest sources of CO₂ emissions, capture of the CO₂ in flue gases from these plants has been identified as an important means for reducing atmospheric CO₂ emissions. To that end, oxygen firing is a promising boiler technology being developed to capture CO₂ from flue gases of both existing and new power plants.

In an oxygen fired power plant, a fossil fuel (such as coal, for example) is burned in a combustion process in a combustion system of the power plant in a similar manner as in a conventional, e.g., air fired, power plant. In the oxygen fired power plant, however, oxygen and recirculated flue gas are used instead of air as an oxidizer in the combustion process. The recirculated flue gas contains primarily CO₂ gas; as a result, the furnace generates a CO₂ rich flue gas stream. The CO₂ rich flue gas is processed by a gas processing system, which captures the CO₂ from the flue gas prior to exhausting the flue gas to the atmosphere via a stack. In a typical oxygen-fired power plant, CO₂ levels in the flue gas leaving the furnace are reduced by more than 90% (percent-by-volume), as compared to flue gas leaving a power plant without a gas processing system, before reaching the stack.

Air leakage contributes to an increase in O₂ and N₂ concentrations, plus other impurities in the flue gas. One way that air leaks into the flue gas is in regenerative heat exchanger, specifically regenerative air heaters, for example. More particularly, high pressure air on an air side of the regenerative air heater leaks over to a relatively lower pressure flue gas side, thereby increasing the concentrations of its constituents in the flue gas. Air leakage into the flue gas can be significant. For example, air leakage into a typical pulverized coal boiler may be as high as approximately 5% of the total combustion air, and older boilers may have even more air leakage.

FIGS. 1A and FIG. 1B generally depict a conventional air preheater 10, and more particularly, a rotary regenerative air preheater 10. The air preheater 10 has a rotor 12 rotatably mounted in a housing 14. The rotor 12 includes partitions 16 extending radially outward from a rotor post 18 toward an outer periphery of the rotor 12. The partitions 16 define compartments 20 therebetween for containing heat exchange element basket assemblies 22. Each heat exchange basket assembly 22 has a predetermined effective heat transfer area (typically on the order of several thousand square feet) of specially formed sheets of heat transfer surfaces, commonly referred to as heat exchange elements 42.

In the conventional rotary regenerative air preheater 10, a flue gas stream 28 and a combustion air stream 34 enter the rotor 12 from respective opposite sides thereof, and pass in substantially opposite directions over the heat exchange elements 42 housed within the heat exchange element basket assemblies 22. More particularly, a cold air inlet 30 and a cooled flue gas outlet 26 are disposed at a first side of the heat exchanger (generally referred to as a cold end 44), while a hot flue gas inlet 24 and a heated air outlet 32 are disposed at a second side, opposite the first side, of the air preheater 10 (generally referred to as a hot end 46). Sector plates 36 extend across the housing 14 adjacent to upper and lower faces of the rotor 12. The sector plates 36 divide the air preheater 10 into an air sector 38 and a flue gas sector 40.

The arrows shown in FIG. 1A and FIG. 1B indicate a direction of travel of the flue gas stream 28 and the combustion air stream 34 through the rotor 12, as well as a direction of rotation of the rotor 12. As shown in FIG. 1A and FIG. 1B, the flue gas stream 28 enters through the hot flue gas inlet 24 and transfers heat to the heat exchange elements 42 in the heat exchange element basket assemblies 22 mounted in the compartments 20 positioned in the flue gas sector 40. The heat exchange element basket assemblies 22, heated by the heat transferred from the flue gas stream 28, are then rotated to the air sector 38 of the air preheater 10. Heat from the heat exchange element basket assembly 22 is then transferred to the combustion air stream 34 entering through cold the air inlet 30. The flue gas stream 28, now cooled, exits the preheater 10 through the cooled flue gas outlet 26, while the combustion air stream 34, now heated, exits the preheater 10 through the air outlet 32.

Referring to FIG. 1C, it can be seen that the rotor 12 is dimensioned to fit within an interior of the housing 14. However, an interior void 95 is formed by spaces between the rotor 12 and the housing 14. Due to a pressure differential between the hot flue gas inlet 24 and the heated air outlet 32, a portion of the combustion air stream 34 in the air sector 38 (FIG. 1B) passes over into the flue gas sector 40 (FIG. 1B) of the air preheater 10 via the interior void 95, thereby contaminating the flue gas stream 28 with air. More specifically, and as shown in FIG. 1D, a portion of the combustion air stream 34 flows from the air sector 38 to the flue gas sector 40 along a first path LG1. In addition, portions of the flue gas stream 28 bypass the rotor 12 by flowing along a second path LG2 from the hot flue gas inlet 24 directly to the cooled flue gas outlet 26 via the interior void 95, thus decreasing an efficiency of the air preheater 10. Likewise, other portions of the combustion air stream 34 bypass the rotor 12 by flowing along a third path LG3 from the cold air inlet 30 directly to the heated air outlet 32 via the interior void 95, further decreasing the efficiency of the air preheater 10.

Leakage of the combustion air stream 34 from the air sector 38 to the flue gas sector 40 along the first path LG1 (generally referred to as air leakage) causes flue gas volume in a power plant exhaust flow to increase. As a result, a pressure drop in equipment downstream from the air preheater 10 increases, thereby increasing auxiliary power consumption in components such as induced draft (ID) fans (not shown). Likewise, increased flue gas volume due to air leakage increases size and/or capacity requirements for other power plant components, such as wet flue gas desulfurization (WFGD) units (not shown) or other flue gas clean-up equipment, for example. As a result, costs associated with power plant construction, operation and maintenance are substantially increased due to air leakage.

Moreover, in a power plant equipped with a post combustion carbon dioxide (CO2) capture system (not shown), leakage reduction is even more beneficial. For example, when designing the post combustion CO2 capture system, air leakage needs to be taken into account, and oversizing capture vessels of the CO2 capture system is expensive. Additionally, the ID fan needs to overcome an additional pressure drop from the CO2 capture system itself, and air leakage thereby further increases auxiliary power requirements. In some cases, the combined increased pressure drop due to air leakage even requires a separate booster fan to be installed in the power plant. Air leakage into the flue gas increases the concentration of free oxygen in the flue gas, and therefore, can also adversely affect oxygen-sensitive CO2 capture chemicals, thereby increasing chemical costs in the power plant having the CO2 capture system.

In light of the abovementioned problems associated with the conventional air preheater 10, steps have been taken in attempts to reduce air leakage, such as by using of a series of seals within the air preheater 10 to minimize leakage of the combustion air stream 34 from the air sector 38 to the flue gas sector 40. Referring to FIG. 2A, for example, a conventional air preheater 110 includes a rotor 112 mounted in a housing 114. The rotor 112 includes a rotor post 118 and is dimensioned to fit within an interior of the housing 114. In attempts to minimize air leakage, seals 220, 222, 224, 226, 228 and 230 are provided. The seals 220, 222, 224, 226, 228 and 230 extend from an interior surface of the housing 114 inward toward the rotor 112 and are positioned in spaces within an interior void 195 to reduce an amount of the combustion air stream 34 in the air sector 38 (FIG. 1B) from crossing into the flue gas stream 28 in the flue gas sector 40 (FIG. 1B). More specifically, as shown in FIG. 2A and FIG. 2B, seals 222 and 224 define a plenum “A” which receives the flue gas stream 28 via a hot flue gas inlet 124. Similarly, seals 220 and 230 define a plenum “B” from which the flue gas stream 28, having passed through the rotor 112, is expelled via a cooled flue gas outlet 126. Further, seals 220 and 228 define a plenum “C” which receives the combustion air stream 34 via a cold air inlet 130, and seals 222 and 226 define a plenum “D” from which the air stream 34, having passed through the rotor 112, is expelled via a heated air outlet 132. Seals 220 and 222 also define a plenum “E”, while seals 224 and 226 define a plenum “F”. Seals 228 and 230, having the rotor post 118 disposed therebetween, also form a plenum “G”, as shown in FIGS. 2A and 2C.

Thus, in an effort to reduce air leakage, the conventional air preheater 110 includes the seals 220, 222, 224, 226, 228 and 230. Air heater leakage is due in large part to deflection of the rotor after it has been heated from cold to hot conditions. A hot end of the rotor deflects axially more than a cold end thereof, and therefore, gaps between the seals are different, contributing to leakage, e.g., from plenums “D” and/or “C” to plenums “A” and/or “B”, respectively, via plenums “F” and/or “G”, respectively. Air leakage, e.g., along the first path LG1 (FIG. 2C), will now be described in further detail with reference to FIGS. 2D and 2E.

FIG. 2D is a top plan view of a conventional tri-sector regenerative air preheater 310. In the tri-sector regenerative air preheater 310, seals 332, 334 and 336 are provided and divide an interior of the air preheater 310 into three plenums 360, 362 and 364. Specifically, plenum 360 is a primary air (PA) plenum 360, and generally has the highest pressure level of the three plenums 360, 362 and 364. Plenum 362 is a secondary air (SA) plenum 362 and generally has the second highest pressure level of the three plenums 360, 362 and 364, while plenum 364 is a flue gas (FG) plenum 364 and has the lowest pressure level of the three plenums 360, 362 and 364. Thus, a pressure in the PA plenum 360 is greater that pressures in both the SA plenum 362 and the FG plenum 364, while a pressure in the SA plenum 362 is greater than the pressure in the FG plenum 364 but less than the pressure in the PA plenum 360, and the pressure in the FG plenum 364 is less the pressures of both the PA plenum 360 and then SA plenum 362.

FIG. 2E is a top plan view of a conventional quad-sector regenerative air preheater 410. In the quad-sector regenerative air preheater 410, seals 432, 433, 434 and 435 are provided and divide an interior of the air preheater 410 into four plenums 460, 462, 463 and 464. Plenum 460 is a PA plenum 460 and generally has the highest pressure level of the four plenums 460, 462, 463 and 464. Plenums 462 and 463 are SA plenums 462, 463 having equal pressures (and generally the second highest pressure level of the four plenums 460, 462, 463 and 464), while plenum 464 is a FG plenum 464 and has the lowest pressure level of the four plenums 460, 462, 463 and 464.

In FIGS. 2D and 2E, broken arrows (labeled “Flow”) depict flow of gases from plenums at higher pressure into plenums at relatively lower pressures. Specifically, in the conventional tri-sector regenerative air preheater 310, air leakage occurs from both the PA plenum 360 and the SA plenum 362 into the FG plenum 364, as shown in FIG. 2D. Likewise, in the conventional quad-sector regenerative air preheater 410, air leakage occurs from both SA plenums 462 and 463 into the FG plenum 464, as shown in FIG. 2E.

Thus, as described above with reference to FIGS. 2C, 2D and 2E, air leakage still occurs in a conventional air preheater, despite the addition of seals designed to prevent the air leakage. Accordingly, it is desirable to develop an air preheater having substantially reduced and/or effectively minimized air leakage.

### SUMMARY

According to the aspects illustrated herein, there is provided a heat exchanger for transferring heat between a first gas flow and a second gas flow. The heat exchanger includes a housing having a first inlet plenum for receiving the first gas flow, a first outlet plenum for discharging the first gas flow, a second inlet plenum for receiving the second gas flow, and a second outlet plenum for discharging the second gas flow. The heat exchanger further includes heat exchange elements disposed within the housing. Radial seals are disposed between the housing and the heating elements that define a radial plenum disposed between the first inlet plenum and the second outlet plenum, and between the second inlet plenum and the first outlet plenum. Axial seals are further disposed between the housing and the heating elements to define an axial plenum disposed between the first inlet and outlet plenums, and the second inlet and outlet plenum. A third gas flow is provided in the radial plenum and the axial plenum to reduce the leakage between the first gas flow and the second gas flow.

According to the other aspects illustrated herein, a method for reducing gas leakage between a first gas flow and a second gas flow passing through a heat exchanger. The method includes providing a heat exchanger. The heat exchanger includes a housing having a first inlet plenum for receiving the first gas flow, a first outlet plenum for discharging the first gas flow, a second inlet plenum for receiving the second gas flow, and a second outlet plenum for discharging the second gas flow. The heat exchanger further includes heat exchange elements disposed within the housing. Radial seals are disposed between the housing and the heating elements that define a radial plenum disposed between the first inlet plenum and the second outlet plenum and between the second inlet plenum and the first outlet plenum. Axial seals are disposed between the housing and the heating elements to define an axial plenum disposed between the first inlet and outlet plenums and the second inlet and outlet plenum. The method further includes providing a third gas flow to the radial plenum and the axial plenum to reduce the leakage between the first gas flow and the second gas flow.

The above described and other features are exemplified by the following figures and detailed description.

### BRIEF DESCRIPTION OF THE DRAWINGS

Referring now to the figures, and wherein the like elements are numbered alike:

FIG. 1A is a perspective view of an air preheater of the prior art;

FIGS. 1B-1D and 2A-2C are partial cross-sectional views of an air preheater of the prior art;

FIGS. 2D and 2E are top plan views of air preheaters of the prior art;

FIG. 3 is a partial cross-sectional view of an air preheater according to an exemplary embodiment of the present invention;

FIG. 4A is a top plan view of an air preheater according to an alternative exemplary embodiment of the present invention; and

FIG. 4B is a top plan view of an air preheater according to another alternative exemplary embodiment of the present invention.

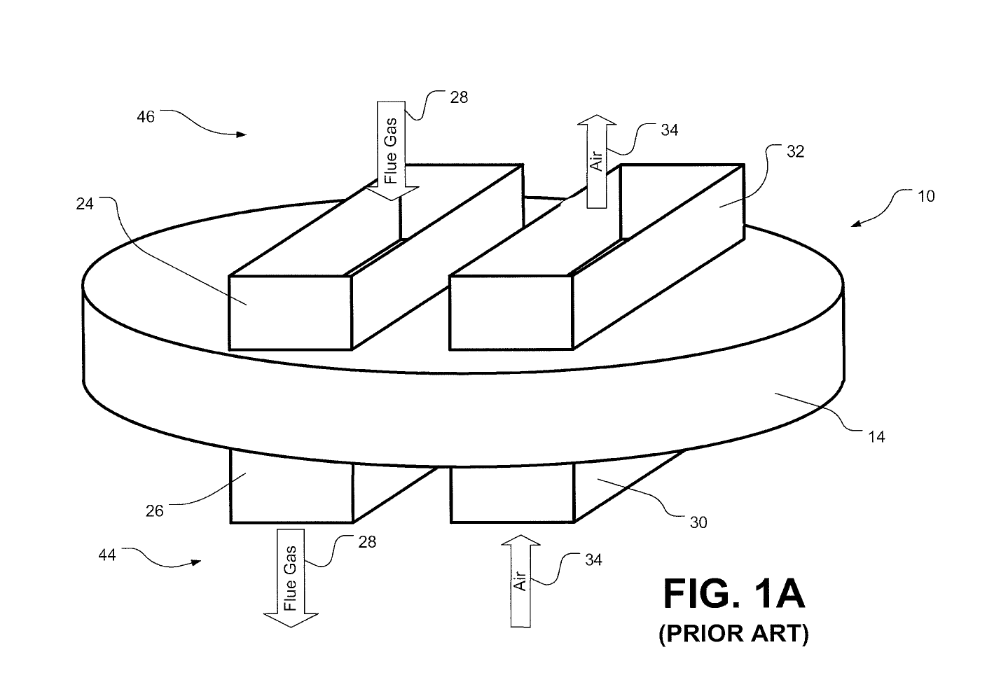

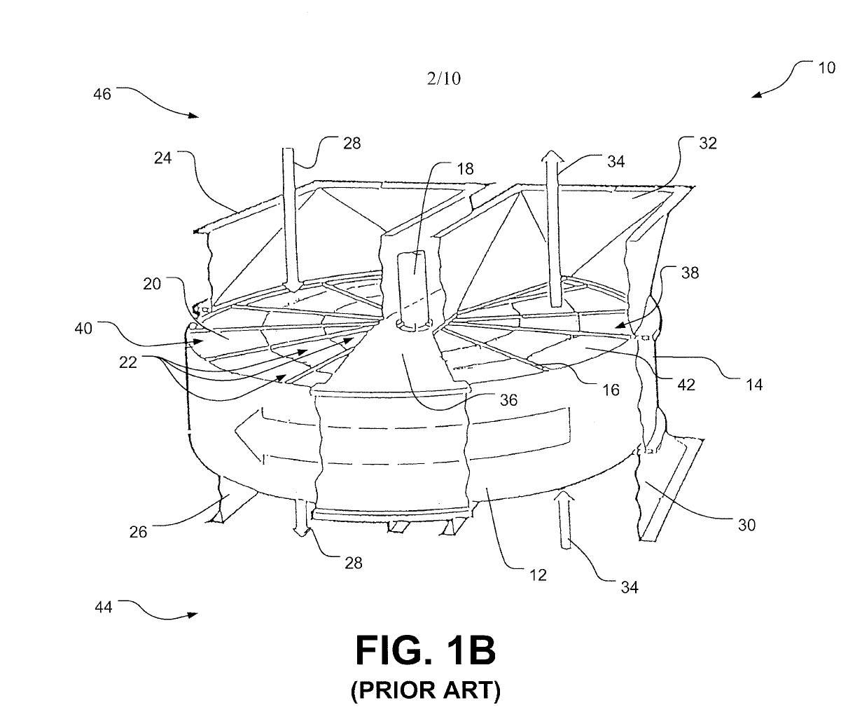

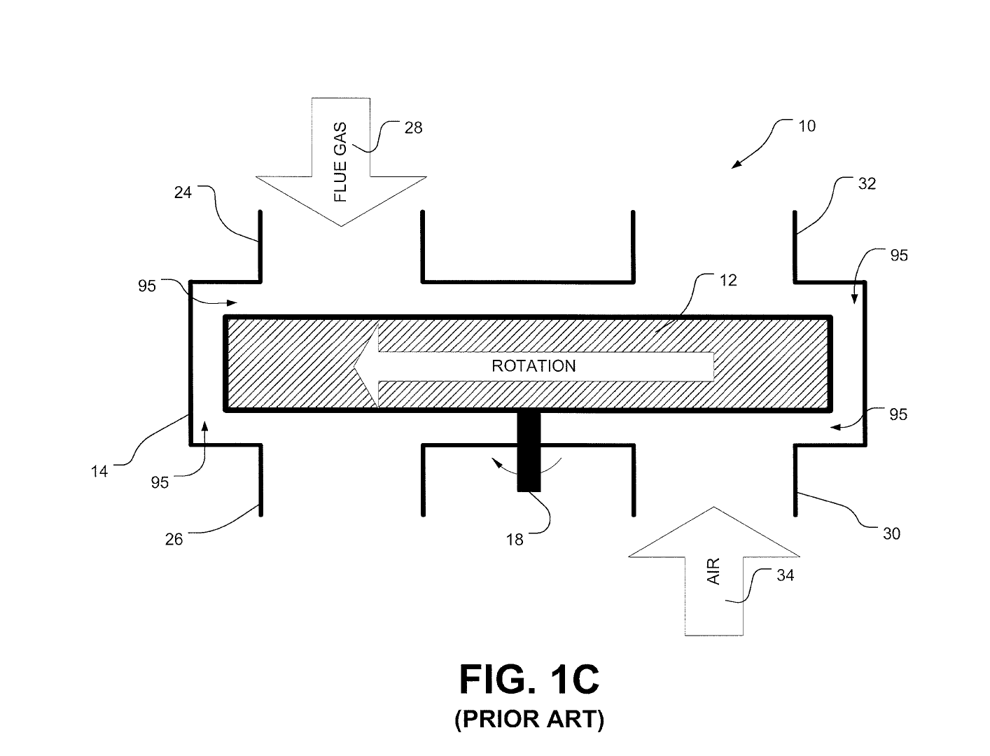

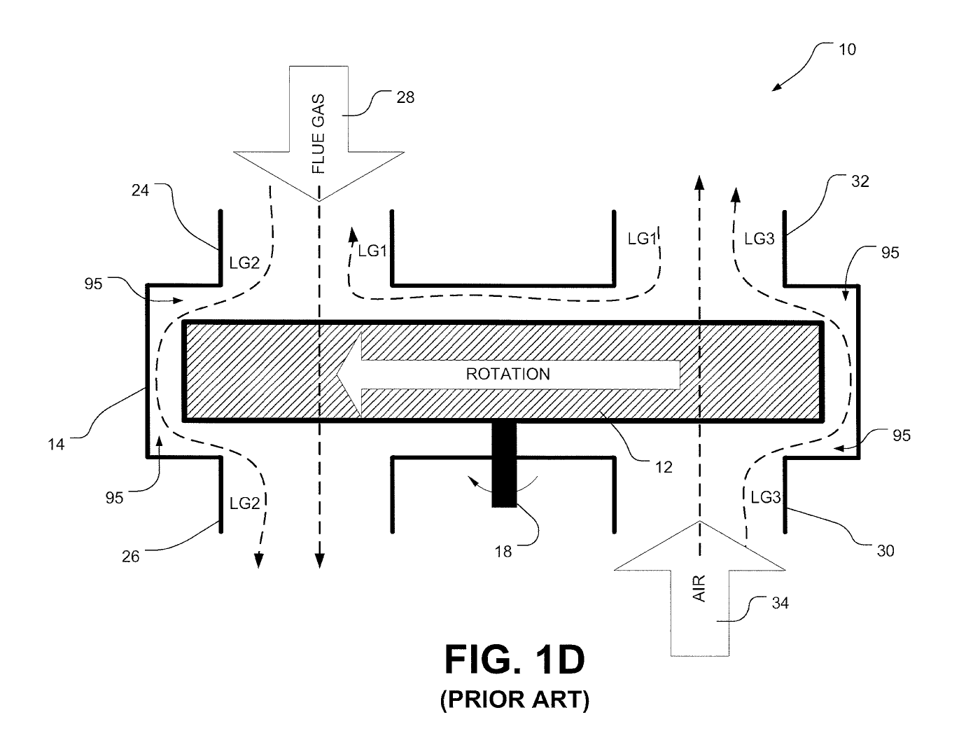

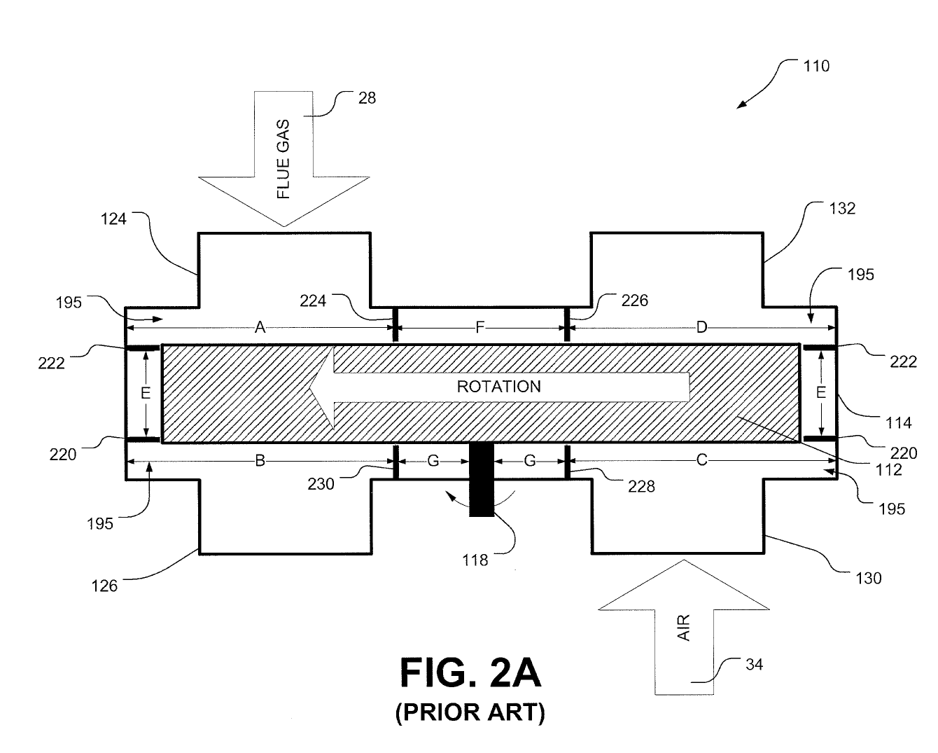

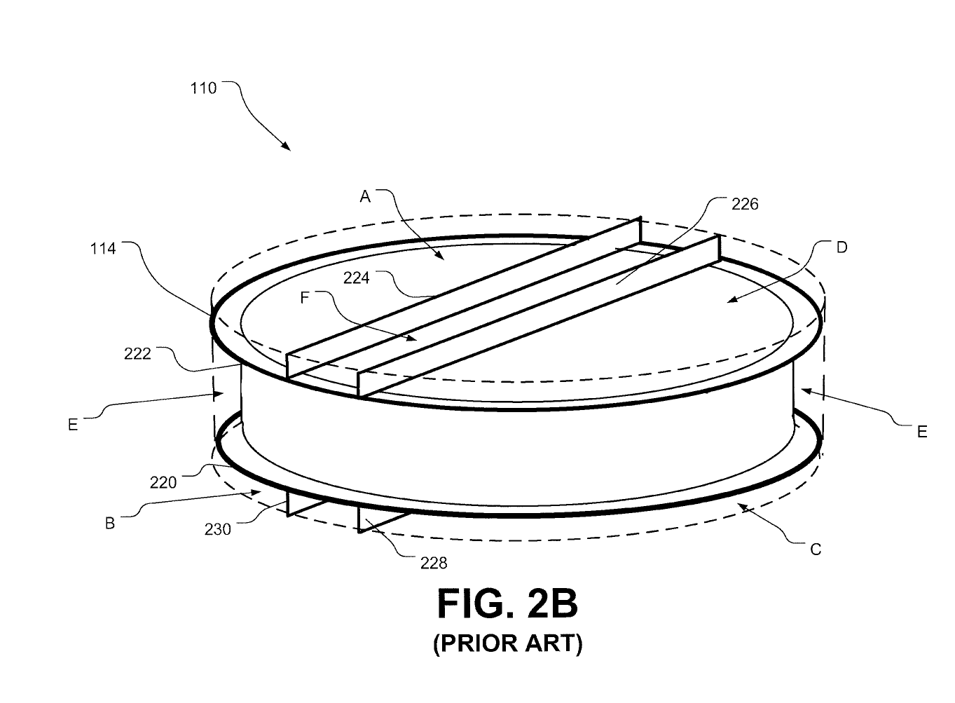

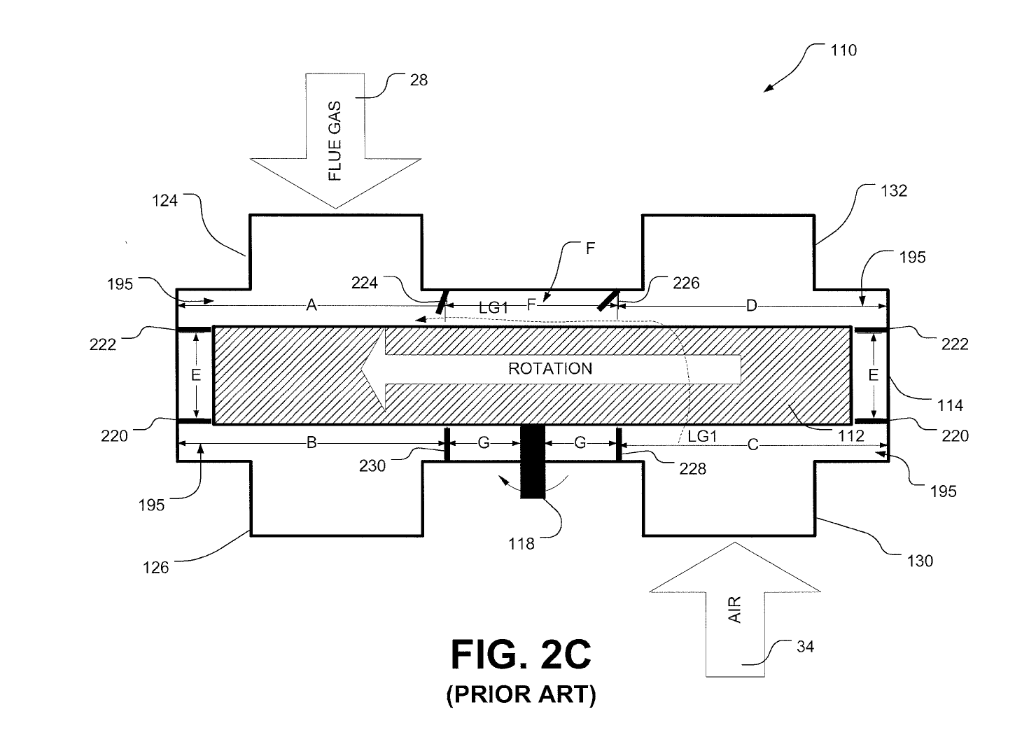

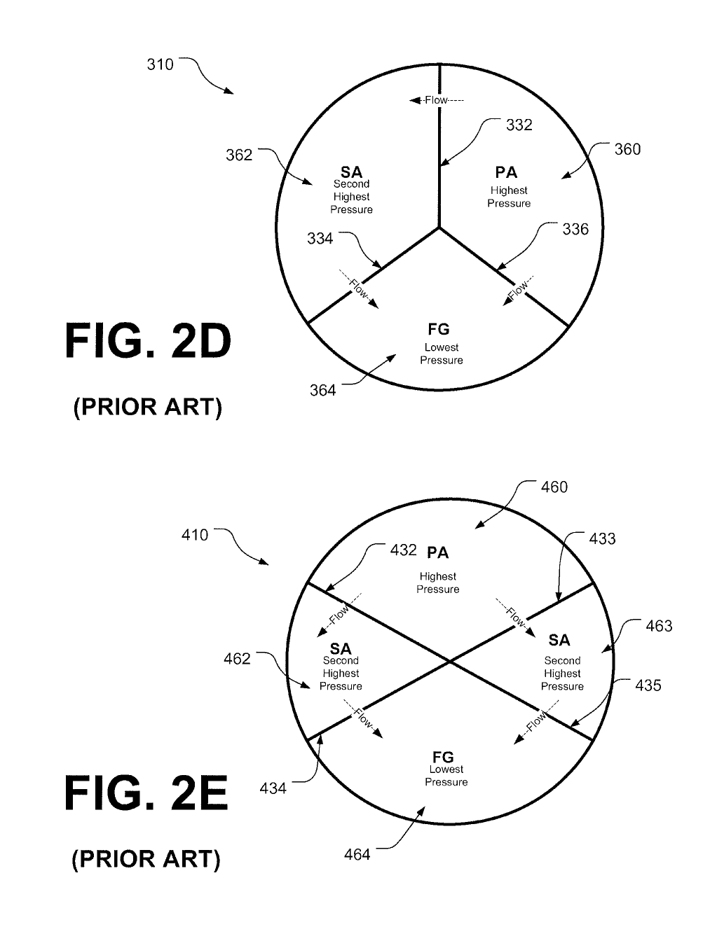

### DETAILED DESCRIPTION

Disclosed herein is a regenerative heat exchanger, and more specifically, a regenerative air preheater for a power plant. The power plant may be an oxygen-fired power plant, or an air-fired power plant, a pulverized coal power plant, or a circulating fluidized bed power plant with or without CO₂ capture. While the present invention will be shown and described in conjunction with a power plant, the invention contemplates such a regenerative heat exchanger for other applications.

As will now be described in further detail with reference to the accompanying drawings, the heat exchanger, for example an air preheater, according to an exemplary embodiment provides benefits which include, but are not limited to, substantially reduced and/or effectively minimized air leakage from the air side of the heat exchanger to the gas side of the heat exchanger. This feature is particularly beneficial for limiting the flow or addition of oxygen to the flue gas from a furnace or other fossil-fuel combustion system as a result of leakage of air into the flue gas as the flue gas flow passes through the heat exchanger. The addition of oxygen to the flue gas is detrimental to the life and performance of CO₂ capture solvents used in a post-combustion capture system located downstream of the heat exchanger gas side discharge.

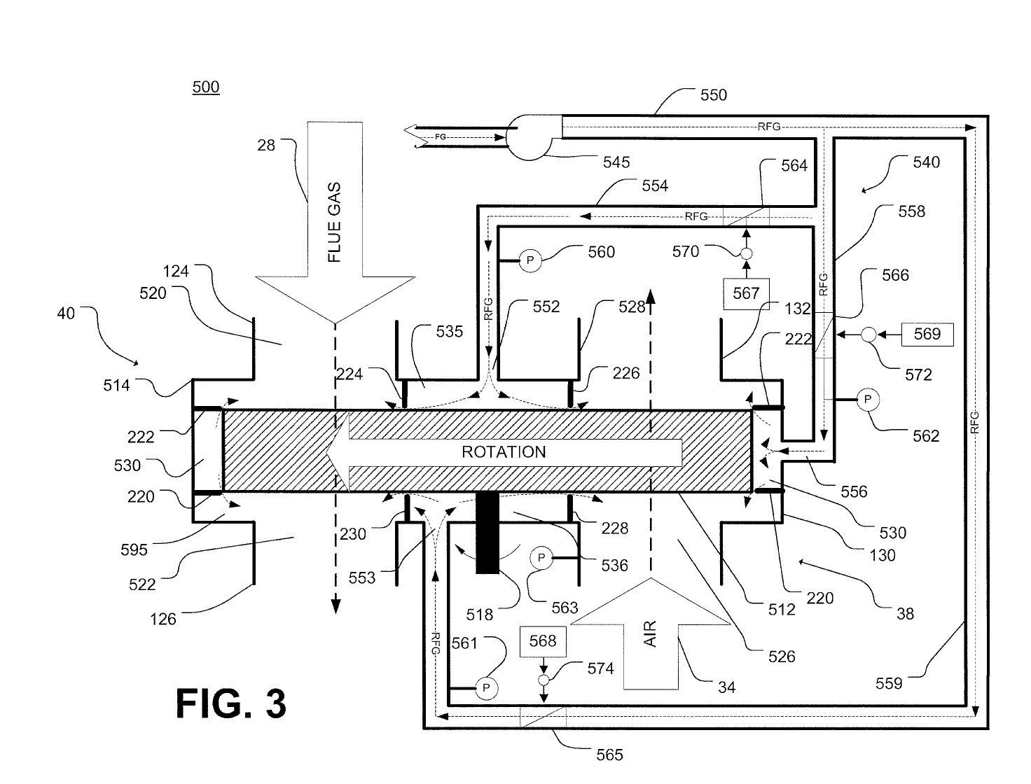

Referring to FIG. 3, a regenerative air preheater 500 according to an exemplary embodiment includes a rotor 512 rotatably mounted in a housing 514. The rotor 512, having heat exchange elements, includes a rotor post 518 and is disposed in an interior space of the housing 514. Axial seals 220, 222 and radial seals 224, 226, 228 and 230 are disposed at various locations between the rotor 512 and the housing 514. Specifically, the axial seals 220, 222 and the radial seals 224, 226, 228 and 230 extend from an interior surface of the housing 514 inward toward the rotor 512 and are positioned in spaces within an interior void 595 to reduce an amount of a combustion air stream 34 in an air sector 38 of the air preheater 500 from crossing into a flue gas stream 28 in a flue gas sector 40 thereof, as shown in FIG. 3. Moreover, axial seal 222 and radial seal 224 define a flue gas inlet plenum 520 which receives the flue gas stream 28 via a hot flue gas inlet 124. Similarly, axial seal 220 and radial seal 230 define a flue gas outlet plenum 522 from which the flue gas stream 28, having passed through the rotor 512, is expelled via a cooled flue gas outlet 126. Further, axial seal 220 and radial seal 228 define an air inlet plenum 526 which receives the combustion air stream 34 via a cold air inlet 130, and axial seal 222 and radial seal 226 define an air outlet plenum 528 from which the air stream 34, having passed through the rotor 512, is expelled via a heated air outlet 132. Axial seals 220 and 222 further define an axial plenum 530, while radial seals 224 and 226 further define a hot radial plenum 535. Radial seals 228 and 230 define a cold radial plenum 536.

Still referring to FIG. 3, the air preheater 500 according to an exemplary embodiment further includes piping or duct system 540 to provided recirculated flue gas to the air preheater 500. The recirculated piping system 540 includes a purge fan 545, an intake of which is connected to a main flue gas exhaust of the power plant (not shown). Specifically, the purge fan 545 receives cooled flue gas from downstream of the air preheater 500, and supplies the cooled flue gas to the piping system 540 as recirculated flue gas (RFG). More particularly, the RFG is flue gas which has been cooled by a regenerative air heater, and which has had particulate and gaseous emissions removed by process stream cleanup equipment installed downstream of the regenerative air heater. The process stream cleanup equipment generally includes a dry electrostatic precipitator or baghouse to remove solid particulates, a flue gas scrubber system to remove gaseous emissions and, if desired, a wet electrostatic precipitator to remove selective solid and gaseous emissions. The purge fan 545 supplies the RFG to an RFG supply line 550. The RFG is supplied to RFG radial inlets 552 and 553, in fluid communication with the hot radial plenum 535 and the cold radial plenum 536, respectively, via radial supply lines 554 and 559, respectively. The RFG is also supplied to an RFG axial inlet 556, in fluid communication with the axial plenum 530, via an axial supply line 554, as shown in FIG. 3.

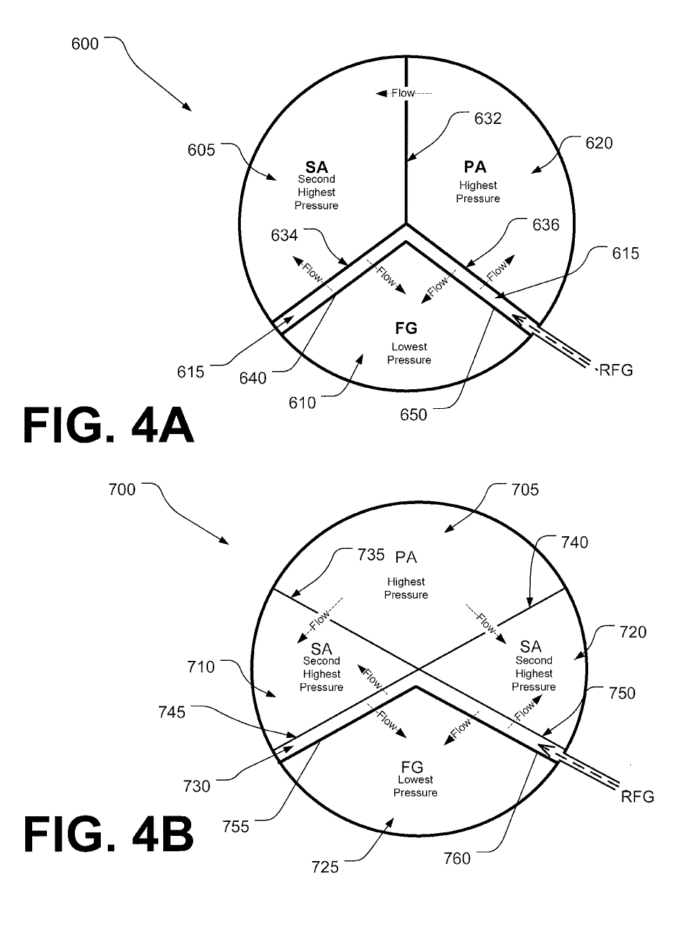

In an exemplary embodiment, a pressure control part, described in greater detail below, maintains a pressure of the RFG supplied to the RFG radial inlets 552 and 553, and the RFG axial inlet 556 such that a pressure, e.g., a differential pressure, between the air sector 38 and the flue gas sector 40 of the air preheater 500 is maintained at a predetermined value. Specifically, the pressure control part according to an exemplary embodiment controls respective pressures of the RFG at the RFG radial inlets 552 and 553, and the RFG axial inlet 556 such that these pressures are maintained substantially equal to or greater than a pressure existing in the secondary air (SA) sector of the air preheater. As a result, air leakage from a SA plenum and/or a primary air (PA) plenum into a flue gas plenum of the air preheater 500 is substantially reduced and/or effectively minimized, as will be described in further detail below with reference to FIGS. 4A and 4B. The fluid that does leak beneath the axial seals 220, 222 and radial seals 224, 226, 228, 230 into the flue gas stream is cooled flue gas which contains substantially less free oxygen than the air flow through the primary and secondary air sectors of the air preheater. More specifically, the air flow through the primary and secondary air sectors of the air preheater may typically contain a nominal 23% oxygen (by weight)concentration, while the cooled flue gas may typically contain a nominal 3-5% oxygen concentration. Thus the flue gas leaving the air preheater 500 is not enriched with the free oxygen that exists in the air streams, and consequently, the negative impact on oxygen-sensitive flue gas clean up equipment located downstream of the air preheater, including, but not limited to, CO₂ removal equipment, is not adversely impacted.

Still referring to FIG. 3, each pressure control part according to an exemplary embodiment includes a pressure sensor 560, 561, 563, an air inlet pressure sensor 563, a pressure controller 570, 572, 574, and a RFG supply damper 564, 565, 566. In an exemplary embodiment, the radial RFG supply dampers 564 and 565 and the axial RFG supply damper 566 are motor-controlled dampers that open and close in response to control signals provided by respective pressure controller 570, 572, 574, whereby the respective control signals are indicative of a differential pressure 567 between the hot radial plenum 535 and the air inlet plenum 526, a differential pressure 568 between the cold radial plenum 536 and the air inlet plenum 526, and a differential pressure 569 between the axial plenum 530 and the air inlet plenum 526. To control the pressure in the RFG radial inlet 552 to ensure the pressure in the hot radial plenum 535 is greater than or equal to the pressure in the air inlet plenum 526, the radial pressure sensor 560 and the air inlet pressure sensor 563 sense respective pressures to provide a first differential pressure signal 567, which is used to control the actuation of the radial RFG supply damper 564. A position of the radial RFG supply damper 564 is then controlled, according to the first differential pressure signal 567, to maintain the pressure in the RFG radial inlet 552 at a desired value or, alternatively, in a desired range. Likewise, to control the pressure in the RFG radial inlet 553 to ensure the pressure in the cold radial plenum 536 is greater than or equal to the pressure in the air inlet plenum 526, the radial pressure sensor 561 and the air inlet pressure sensor 563 sense respective pressures to provide a second differential pressure signal 568, which is used to control the actuation of the radial RFG supply damper 565. A position of the radial RFG supply damper 565 is then controlled, according to the second differential pressure signal 568, to maintain the pressure in the RFG radial inlet 553 at a desired value or, alternatively, in a desired range. In a similar manner, to control the pressure in the RFG axial inlet 556 to ensure the pressure in the axial plenum 530 is greater than or equal to the pressure in the air inlet plenum 526, the axial pressure sensor 562 and the air inlet pressure sensor 563 sense respective pressures to provide a third differential pressure signal 569, which is used to control the actuation of the axial RFG supply damper 566. A position of the axial RFG supply damper 566 is then controlled, according to the third differential pressure signal 569, to maintain the pressure in the RFG axial inlet 552 at a desired value or, alternatively, in a desired range.

In an exemplary embodiment, the separate component which provides the signals to the radial RFG supply damper 564 and/or the axial RFG supply damper 566 is a distributed control system (DCS), a controller or a processor, for example, to provide intelligent and/or variable control of the pressure differential. In an exemplary embodiment, for example, the desired value or range may be fixed, programmable or operator adjustable. Moreover, variations in plant load are accommodated via the use of a pressure control system, described in further detail below with reference to FIG. 3, which monitors and maintains a proper differential pressure between the air and gas sides of the air preheater 500 to ensure the flow of air to the gas side is effectively controlled.

The air preheater 500 according to an exemplary embodiment is a regenerative air preheater 500 and, more specifically, a rotary regenerative air preheater 500, as described above with reference to FIG. 3. In addition, an air preheater according to an exemplary embodiment is a tri-sector regenerative air preheater 600, as shown in FIG. 4A. In an alternative exemplary embodiment, the rotary regenerative air preheater 500 is a quad-sector regenerative air preheater 700, as shown in FIG. 4B. It will be noted that alternative exemplary embodiments are not limited to the foregoing types or configurations of heat exchangers. For example, an alternative exemplary embodiment includes a bi-sector regenerative air preheater.

Referring now to FIG. 4A, the tri-sector regenerative air preheater 600 includes a secondary air plenum 605, a flue gas plenum 610 and a primary air plenum 620. The tri-sector regenerative air preheater 600 according to an exemplary embodiment further includes an intermediate plenum 615, as shown in FIG. 4A.

In the tri-sector regenerative air preheater 600, seals 632, 634 and 636 divide an interior of the air preheater 600 into the secondary air plenum 605, the flue gas plenum 610 and the primary air plenum 620, while the seals 634 and 636, along with seals 640 and 650, define the RFG plenum 615 therebetween, as shown in FIG. 4A.

As described above in greater detail with reference to FIG. 3, the pressure control part maintains a pressure of the RFG supplied to the RFG radial inlet 552 and the RFG axial inlet 556 such that a pressure differential between the air sector 38 and the flue gas sector 40 of the air preheater 600 is maintained at a predetermined value. Specifically, and with reference to FIG. 4A, the pressure control part according to an exemplary embodiment maintains a pressure of the RFG such that a pressure in the RFG plenum 615 is substantially equal to, e.g., is substantially the same as, a pressure in the secondary air plenum 605. In an alternative exemplary embodiment however, the pressure of the RFG is slightly greater than pressures in the secondary and/or primary air sectors. As a result, recirculated flue gas flows into the flue gas sector as well as the primary and secondary air sectors, effectively reducing the air flow beneath the radial and axial seals into the flue gas to zero.

As a result, in the air preheater 600 according to an exemplary embodiment, a differential pressure between the primary air plenum 620 and each of the secondary air plenum 605, the RFG plenum 615 and the flue gas plenum 610 are such that the pressure of the RFG in a portion of the flue gas plenum 615 proximate to the secondary air plenum 605 will generally be less than the pressure of the RFG in a portion of the flue gas plenum 615 plenum proximate to the primary plenum 620. Therefore, the flue gas pressure in the respective portions of the flue gas plenum 615 is greater than the respective primary or secondary air static pressure. Accordingly, any leakage which passes beneath the seals will be RFG from the RFG plenum 615 into the primary air plenum 620, the secondary air plenum 605 and/or the flue gas plenum 610. In addition, by reducing the differential pressure across the seal separating the RFG and the FG, the quantity of leakage is reduced.

Accordingly, air leakage, e.g., leakage of primary air and/or secondary air from the primary air plenum 620 and/or the secondary air plenum 605, respectively, into the flue gas plenum 610 is substantially reduced and/or effectively minimized in the air preheater 600 according to an exemplary embodiment.

Referring now to FIG. 4B, the quad-sector regenerative air preheater 700 according to an exemplary embodiment includes at least one air plenum, e.g., a primary air plenum 705, a first secondary air plenum 710 and a second secondary air plenum 720, a flue gas plenum 725, and an intermediate plenum, e.g., an RFG plenum 730. In an exemplary embodiment, seals 735, 740, 745 and 750 divide an interior of the air preheater 700 into the primary air plenum 705, the first secondary air plenum 710, the second secondary air plenum 720 and the flue gas plenum 725, while the seals 745 and 750, in conjunction with seals 755 and 760, define the RFG plenum 730 therebetween.

Similar to as was described above in greater detail with reference to FIG. 4A, in the air heater 700 according to an exemplary embodiment, the primary air plenum 735 has the highest pressure of the plenums. Likewise, the first secondary air plenum 710, the second secondary air plenum 720 and the RFG plenum 730 have substantially equal pressures which are both less than the pressure of the primary air plenum 735, but greater than a pressure of the flue gas plenum 725, while the flue gas plenum 725 has a pressure lower than each of the primary air plenum 735, the first secondary air plenum 710, the second secondary air plenum 720 and the RFG plenum 730. As a result, the primary air plenum 735 is isolated from the flue gas plenum 725 in the air heater 700 according to an exemplary embodiment. The flue gas plenum 725 is further isolated from both the first secondary air plenum 710 and the second secondary air plenum 720 by the RFG plenum 730 disposed therebetween.

Accordingly, air leakage, e.g., leakage of primary air and/or secondary air from the primary air plenum 735, the first secondary air plenum 710 and/or the second secondary air plenum 720 into the flue gas plenum 725 is substantially reduced and/or effectively minimized in the air preheater 700 according to an exemplary embodiment.

Thus, a rotary regenerative air preheater according to exemplary embodiments described herein provides at least the advantage of substantially reduced and/or effectively minimized air leakage, thus eliminating the increase in the free oxygen concentration in the flue gas leaving the air preheater. As a result, size and/or electrical power requirements for components of a gas processing system of a power plant are substantially reduced, thereby resulting in a substantial reduction in manufacturing, operational and maintenance costs thereof.

It will be noted that alternative exemplary embodiments are not limited to those described herein. For example, another alternative exemplary provides a method of reducing air leakage in an air preheater for a power plant. More particularly, the method includes receiving combustion air in an air plenum, receiving flue gas in a flue gas plenum, and supplying recirculated flue gas, which contains less free oxygen than the combustion air, to a recirculated flue gas plenum disposed between the air plenum and the flue gas plenum. As a result, an amount of the combustion air which leaks into the flue gas plenum is substantially decreased and/or effectively minimized.

It will be further noted that alternative exemplary embodiments are not limited to use with any particular type of power plant. For example, for purposes of illustration, an air preheater has been described herein with particular reference to an oxygen fired boiler. However, the air preheater may be used with conventional, e.g., non-oxygen fired boilers, as well as CO₂ capture ready boilers, while alternate exemplary embodiments are not limited thereto.

While embodiment of the present invention has been described as having specific gases 28,34 flowing through the heat exchanger 500, such as air and flue gases, one will appreciate that any gas may be heated or cooled by any other gas. Further, the gas provided to the axial plenum 530 and radial plenum(s) 535,536 may be any gas such that the composition of the gas has a small amount of or no unwanted elements, such as oxygen, that will flow into the gases 28,34 flowing through the heat exchanger 500.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A heat exchanger for transferring heat between a first gas flow and a second gas flow, the heat exchanger comprising:
a housing having a first inlet plenum for receiving the first gas flow, a first outlet plenum for discharging the first gas flow, a second inlet plenum for receiving the second gas flow, and a second outlet plenum for discharging the second gas flow;
heat exchange elements disposed within the housing;
radial seals disposed between the housing and the heating elements that define a radial plenum disposed between the first inlet plenum and the second outlet plenum and between the second inlet plenum and the first outlet plenum; and
axial seals disposed between the housing and the heating elements to define an axial plenum disposed between the first inlet and outlet plenums and the second inlet and outlet plenum;
wherein a third gas flow is provided in the radial plenum and the axial plenum to reduce the leakage between the first gas flow and the second gas flow.

2. The heat exchanger of claim 1, wherein the heat exchange elements rotate about a rotor post.

3. The heat exchanger of claim 1, wherein the heat exchanger is a regenerative air preheater.

4. The heat exchanger of claim 1, wherein the first gas flow is an air flow and second gas flow is flue gas from a combustion system.

5. The heat exchanger of claim 4, wherein the third gas is recirculated flue gas from the combustion system.

6. The heat exchanger of claim 1, wherein the first gas flow is a substantial oxygen flow and second gas flow is gas flow from a combustion system.

7. The heat exchanger of claim 6, wherein the third gas is recirculated flue gas from the combustion system.

8. The heat exchanger of claim 1, further includes a ductwork system that provides the third gas to the radial plenum and the axial plenum.

9. The heat exchanger of claim 1, wherein the third gas flow is provided at a pressure at least the same as the pressure of the first gas flow.

10. The heat exchanger of claim 1, wherein the third gas flow is provided at a pressure greater than the pressure of the first gas flow.

11. The heat exchanger of claim 1, further comprising:
a radial pressure sensor that measures the radial pressure indicative of pressure of the radial plenum;
an axial pressure sensor that measures the axial pressure indicative of pressure of the axial plenum;
a first gas pressure sensor that measures the first gas pressure indicative of pressure of the first gas air inlet plenum;
a radial damper that actuates between the open and closed position in response to a differential pressure between the radial pressure and the first gas pressure to ensure the radial pressure is equal to or greater than the first gas pressure; and
an axial damper that actuates between the open and closed position in response to a differential pressure between the axial pressure and the first gas pressure to ensure the axial pressure is equal to or greater than the first gas pressure.

12. The heat exchanger of claim 1, wherein the radial plenum comprises a hot radial plenum and a cold radial plenum, the heat exchanger further comprising:
a hot radial pressure sensor that measures the hot radial pressure indicative of pressure of the hot radial plenum;
a cold radial pressure sensor that measures the cold radial pressure indicative of pressure of the cold radial plenum;
an axial pressure sensor that measures the axial pressure indicative of pressure of the axial plenum;
a first gas pressure sensor that measures the first gas pressure indicative of pressure of the first gas air inlet plenum;
a hot radial damper that actuates between the open and closed position in response to a differential pressure between the hot radial pressure and the first gas pressure to ensure the hot radial pressure is equal to or greater than the first gas pressure;
a cold radial damper that actuates between the open and closed position in response to a differential pressure between the cold radial pressure and the first gas pressure to ensure the cold radial pressure is equal to or greater than the first gas pressure; and
an axial damper that actuates between the open and closed position in response to a differential pressure between the axial pressure and the first gas pressure to ensure the axial pressure is equal to or greater than the first gas pressure.

13. The heat exchanger of claim 1, wherein the addition of oxygen to the second gas flow as a result of leakage of the first gas flow into the second gas flow as the second gas flow passes from the second inlet plenum to the second outlet plenum is minimized.

14. A method for reducing gas leakage between a first gas flow and a second gas flow passing through a heat exchanger; said method comprising:
providing a heat exchanger including:
a housing having a first inlet plenum for receiving the first gas flow, a first outlet plenum for discharging the first gas flow, a second inlet plenum for receiving the second gas flow, and a second outlet plenum for discharging the second gas flow;
heat exchange elements disposed within the housing;
radial seals disposed between the housing and the heating elements that define a radial plenum disposed between the first inlet plenum and the second outlet plenum and between the second inlet plenum and the first outlet plenum; and
axial seals disposed between the housing and the heating elements to define an axial plenum disposed between the first inlet and outlet plenums and the second inlet and outlet plenum;
providing a third gas flow to the radial plenum and the axial plenum to reduce the leakage between the first gas flow and the second gas flow.

15. The method of claim 14, wherein the heat exchange elements rotate about a rotor post.

16. The method of claim 14, wherein the heat exchanger is an air preheater.

17. The method of claim 14, wherein the first gas flow is an air flow, second gas flow is flue gas from a combustion system, and the third gas is recirculated flue gas from the combustion system.

18. The method of claim 14, wherein the first gas flow is a substantial oxygen flow, the second gas flow is recirculated gas flow from a combustion system, and the third gas flow is recirculated flue gas from the combustion system.

19. The method of claim 14, wherein the third gas flow is provided at a pressure the same as or greater than the pressure of the first gas flow.

20. The method of claim 14, wherein the addition of oxygen to the second gas flow as a result of leakage of the first gas flow into the second gas flow as the second gas flow passes through the heat exchanger is minimized.

21. The method of claim 14 further comprising:
measuring the radial pressure indicative of pressure of the radial plenum;
measuring the axial pressure indicative of pressure of the axial plenum;
measuring the first gas pressure indicative of pressure of the first gas air inlet plenum;
regulating the pressure of the radial plenum in response to a differential pressure between the radial pressure and the first gas pressure to ensure the radial pressure is equal to or greater than the first gas pressure; and
regulating the pressure of the axial plenum in response to a differential pressure between the axial pressure and the first gas pressure to ensure the axial pressure is equal to or greater than the first gas pressure.
